(19) United States
(12) Patent Application Publication
(10) Pub. No.: US 2005/0139800 A1
(43) Pub. Date: Jun. 30, 2005

(54) Butterfly valve unit

(76) Inventor: Siegfried Deiss, Motzing (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/062,520

(22) Filed: Feb. 22, 2005

Related U.S. Application Data
(63) Continuation of application No. PCT/DE03/02614, filed on Aug. 4, 2003.

(30) Foreign Application Priority Data
Aug. 22, 2002 (DE) 10238572.6

(51) Int. Cl. F16K 1/22

(52) U.S. Cl. 251/305

(57) ABSTRACT

A butterfly valve unit is provided comprising a housing having a connecting sleeve. The sleeve of the unit is configured to accommodate a shaft with a butterfly valve attached thereto. The unit further comprises a fixing device in order to attach the unit to an intake module having a lateral recess. The connecting sleeve is configured to be inserted into the recess of the module in the area corresponding to a butterfly valve pipe section of the intake module.

### CROSS-REFERENCE TO RELATED APPLICATION

This application is a continuation of co-pending International Application No. PCT/DE03/02614 filed Aug. 4, 2003 which designates the United States, and claims priority to German application number DE10238572.6 filed Aug. 22, 2002.

### TECHNICAL FIELD OF THE INVENTION

The invention relates to a butterfly valve unit comprising a housing with a connecting sleeve, the latter accommodating a shaft and a butterfly valve attached to said shaft. The butterfly valve unit is particularly suitable for use in an internal combustion engine.

### BACKGROUND OF THE INVENTION

From DE 198 25 727 A1, a butterfly valve connecting sleeve which serves to adjust the performance of an internal combustion engine and which is located between the outlet of an air filter and the inlet of an intake module of an internal combustion engine is known. The butterfly valve connecting sleeve has a housing which has a connecting sleeve, the latter accommodating a shaft and a butterfly valve attached to said shaft. The butterfly valve connecting sleeves can be fitted by fixing devices to the end of the air filter on the output side and to the inlet of an intake module on the input side.

### SUMMARY OF EMBODIMENTS OF THE INVENTION

It is the object of the invention to develop the well-known butterfly valve unit further in such a way that it is easier and cost-effective to use in different applications.

According to an embodiment of the invention, the butterfly valve unit has a fixing device which allows the butterfly valve unit to be located on an intake module in such a way that the connecting sleeve of the housing of the butterfly valve unit is inserted into a lateral recess of an intake module in the vicinity of a butterfly valve pipe section, radially to the latter.

The lateral recess is provided in the vicinity of the butterfly valve pipe section. It is embodied radially and axially without completely interrupting the pipe section or its surrounding housing, i.e., forming its end. Consequently, the butterfly valve unit makes it easy to provide identical fixing devices for different applications, with, for example, different diameters of the butterfly valve pipe section and the connecting sleeve. This then makes it possible for the butterfly valve to only have to undergo the costly testing for one model from the manufacturer of the internal combustion engines and this can testing then be omitted for uses in other models.

In addition, the butterfly valve unit can easily be located in an intake module. In addition, particularly with an increasing connecting sleeve cross-section, considerably less material is required than for the customary butterfly valve connecting sleeves which are flanged onto an end of the intake module on the inlet side. This is particularly advantageous if the housing is manufactured in an advantageous design made of plastic, since the smaller amount of plastic needed facilitates simpler manufacturing.

### BRIEF DESCRIPTION OF THE DRAWINGS

Embodiments of the invention are explained in greater detail below and on the basis of the accompanying drawings. They are as follows:

FIG. 1 a butterfly valve unit and an intake module,

FIG. 2 the butterfly valve unit according to FIG. 1 in a second embodiment, and

FIG. 3 the butterfly valve unit according to FIG. 1 located in an intake module according to FIG. 1.

Elements with the same design and function have the same reference symbols in all the figures.

### DETAILED DESCRIPTION OF EMBODIMENTS OF THE INVENTION

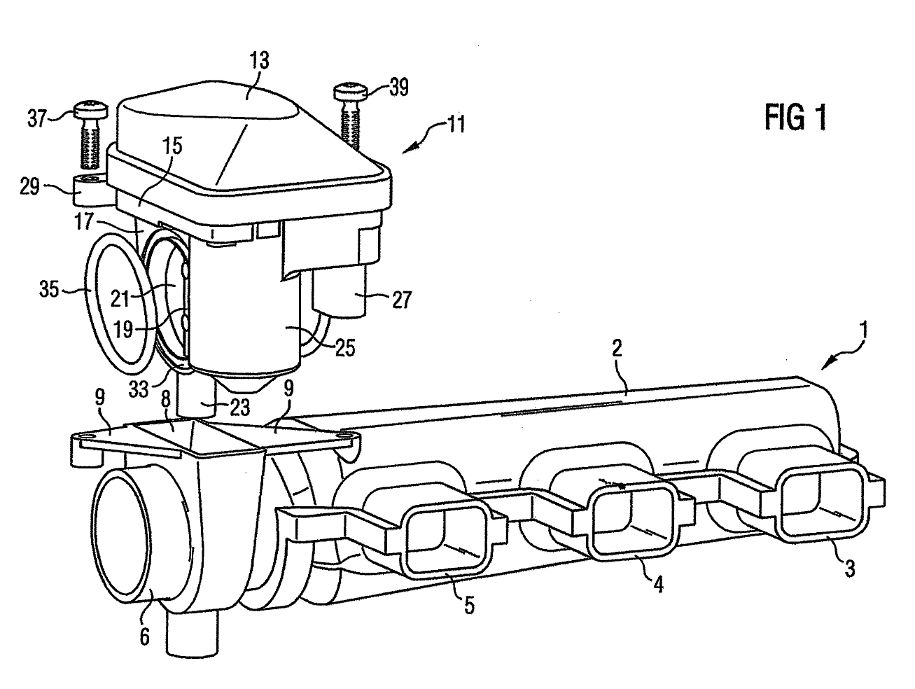

An intake module 1 (FIG. 1) has an accumulator 2 and suction tubes 3 to 5 which are routed to the inlet ports of an internal combustion engine (not shown). In addition, the intake module 1 comprises a butterfly valve pipe section 6 which at its inlet side end is connected directly or indirectly to an air filter. The butterfly valve pipe section 6 has a recess which is embodied radially and axially without the pipe section to completely interrupt this encompassing housing. In addition, a lateral flange 9 is provided adjacent to the recess 8 which serves to secure a butterfly valve unit.

The butterfly valve unit 11 has a housing consisting of a cover 13 and a housing base 15. The base of the housing preferably includes a connecting sleeve 17, the latter accommodating a shaft 19 and a butterfly valve 21 attached to said shaft. The connecting sleeve is preferably only 1 to 5 cm wide in an axial direction. This reduces the mass of the unit accordingly which is of decisive benefit for manufacturing the unit from plastic with the greatest possible precision.

In addition, there is a bearing seat 23 provided on the side of the butterfly valve 21 which faces away from the cover 13 and which is embodied conically, but preferably tapered. This enables on the one hand, the shaft to which the butterfly valve 21 is fitted to be well-supported and, on the other hand, using the outside contour of the bearing seat, for the butterfly valve unit 11 to be fitted reliably and accurately in the intake module.

In addition, the housing has a receptacle 25 for an actuator of the butterfly valve 21 which is preferably embodied as an electric motor with a corresponding transmission. In addition, the housing base 15 advantageously also has a connector 27 which is embodied for accommodating a corresponding mating plug and in this way, with a central control unit, forms the connection to the electrical supply and signal lines of the actuator 25 or a sensor (which is not shown). In addition, a fixing device is provided which is embodied as a lateral flange 29 of the butterfly valve unit. In addition, a groove 33 is provided coaxially to the butterfly valve pipe section, and thereby to the free pipe cross-section of the connecting sleeve, 17 which accommodates an O-ring 35.

The butterfly valve unit is attached to the intake module by means of the flange 29 of the butterfly valve unit and the flange 9 of the intake module 1 preferably by means of the screws 37, 39. In the state introduced in the intake module, the connecting sleeve 17 is inserted into a lateral recess 8 of the intake module in the vicinity of the butterfly valve pipe section 6, radially to the latter. Therefore, the butterfly valve can be inserted as a simple insertion part into the intake module, making it particularly suitable for highly integrated module solutions. This makes an overall exceptionally compact embodiment of the intake module including the butterfly valve possible, which is in particular advantageous since space is frequently at a premium.

With flange 9, the butterfly valve can be fitted to the intake module in a very simple and reliable manner.

The O-ring 35 which is inserted into the groove 33 of the connecting sleeve 17 ensures that there are no leakage currents in the butterfly valve pipe section 6 during operation of the intake module 1. An O-ring here represents a simple and cost-effective available standard part.

In addition, the conical, especially tapered outside contour of the bearing seat 23, allows particularly reliable and accurate fixing of the butterfly valve unit 11 in the intake module 1 to be achieved and at the same time it can be ensured that the shaft 19 of the butterfly valve 21 is very well supported. The housing of the butterfly valve unit 11 is preferably made of plastic.

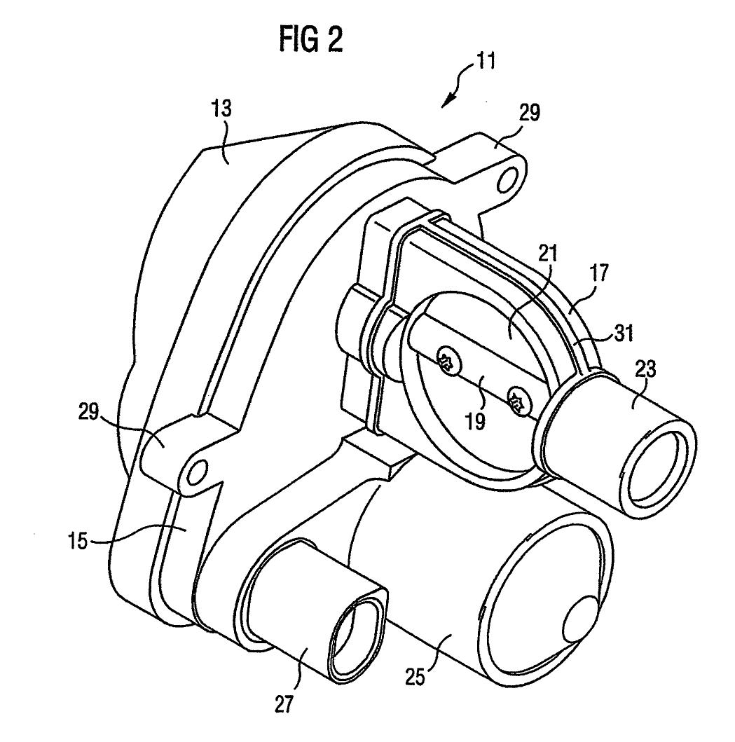

On the one hand, this makes possible cost-effective manufacturing and, on the other hand, a weight saving compared with a part made of metal. The compact design of the connecting sleeve 17 also guarantees that the butterfly valve will function perfectly over the entire temperature range in which the internal combustion engine is operated. FIG. 2 shows the butterfly valve unit which only from the unit shown in FIG. 1 in its different design of seal. With this embodiment, there is a groove 31 along the outside contour of the connecting sleeve 17 which accommodates a seal.

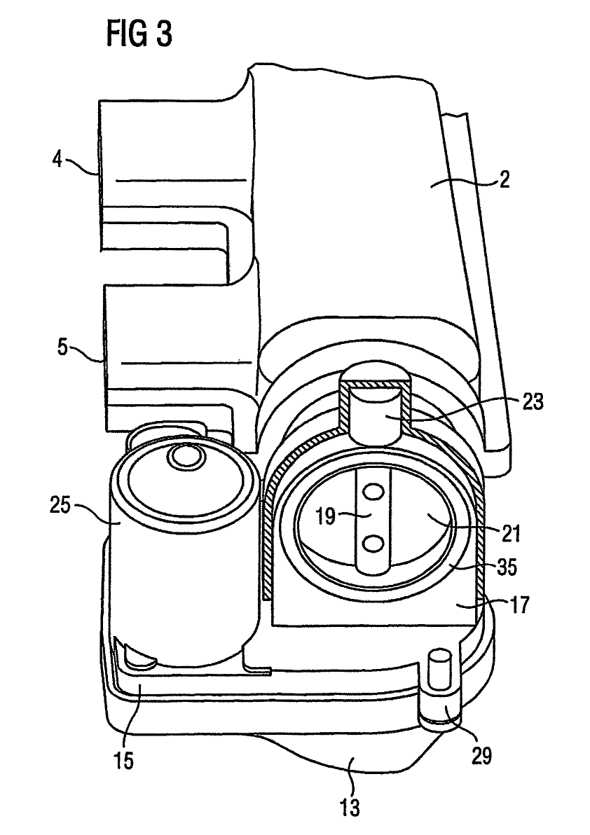

FIG. 3 shows the intake module 1 in the completely assembled state with the butterfly valve unit according to FIG. 1, in which case the butterfly valve pipe section 6 is cut away along the hatched line for a better view.

1. A butterfly valve unit, said unit comprising:
a housing, said housing having a connecting sleeve, said sleeve accommodating a shaft and a butterfly valve, said valve attached to said shaft, and
a fixing device, said fixing device fixing the butterfly valve unit on an intake module, said module having a lateral recess thereon, wherein the connecting sleeve is adapted to be inserted into the lateral recess of the module in the vicinity of a butterfly valve pipe section.

2. A butterfly valve unit according to claim 1, wherein the fixing device comprises a flange.

3. A butterfly valve unit according to claim 1, wherein the connecting sleeve includes a seal for the butterfly valve pipe section.

4. A butterfly valve unit according to claim 3, wherein the seal has a groove running coaxially to the connecting sleeve, said groove accommodating an O-ring.

5. A butterfly valve unit according to claim 1, further comprising a bearing seat with a conical outside contour for a bearing of the shaft.

6. A butterfly valve unit according to claim 5, wherein the bearing seat has a tapered outside contour.

7. A butterfly valve unit according to claim 1, wherein the housing comprises plastic.

8. A butterfly valve unit according to claim 1, wherein the housing consists of plastic.
